(19) United States
(12) Patent Application Publication
(10) Pub. No.: US 2016/0219297 A1
(43) Pub. Date: Jul. 28, 2016

(54) METHOD AND SYSTEM FOR BLOCK MATCHING BASED MOTION ESTIMATION

(71) Applicant: SAMSUNG ELECTRONICS CO., LTD., Suwon-si (KR)

(72) Inventor: Deepak Thumathajira YENKAPPA, Bangalore (IN)

(73) Assignee: SAMSUNG ELECTRONICS CO., LTD., Suwon-si (KR)

(21) Appl. No.: 15/003,868

(22) Filed: Jan. 22, 2016

(30) Foreign Application Priority Data
Jan. 23, 2015 (IN) 363/CHE/2015

(51) Int. Cl. H04N 19/51; H04N 19/167; H04N 19/176

(52) U.S. Cl. CPC H04N 19/51; H04N 19/176; H04N 19/167

(57) ABSTRACT

A method and video encoder for block matching based motion estimation is provided including computing a first cost metric for a search point among plurality of search points in a reference frame with reference to a target macroblock of a candidate frame using a subset of pixels of the target macroblock, determining whether the first cost metric is less than a first minimum value, updating the first minimum value to the first cost metric, and updating a matching position to the search point in response to determining that the first cost metric is less than the first minimum value, and identifying a search point corresponding to the matching position as a best matching position for motion estimation.

### CROSS-REFERENCE TO RELATED APPLICATION

This application claims priority under 35 U.S.C. §119 to Indian Patent Application No. 363/CHE/2015 filed on Jan. 23, 2015, in the Indian Patent Office, the disclosure of which is incorporated herein by reference in its entirety.

### BACKGROUND

1. Field

Method and apparatuses consistent with exemplary embodiments relate to video compression, and more particularly to block matching based motion estimation for video encoding during video compression.

2. Description of Related Art

With rapid development in wireless technology and communication devices, multimedia communication has experienced an exponential rise. Because increasingly large amounts of multimedia data are being be stored or transmitted, video compression or video coding has become critically important.

Video encoders based on compression standards, such as H.264/AVC, extensively employ a block matching based motion estimation for video compression. The block matching based motion estimation process includes partitioning a candidate frame into multiple equally-sized non-overlapping blocks referred as macroblocks. A target macroblock in the candidate frame is compared with the reference frame within a predefined search window using pre-defined search points, under the constraint of a cost metric. Any cost metric, such as a Sum of Absolute Difference (SAD) or Mean of Absolute Difference (MAD), may be used. A best matching position with reference to the target block is obtained when the cost metric function being computed for each search point minimizes for a particular search point. Then, a motion vector (MV) representative of the displacement between the target macroblock and the macroblock of the reference frame associated with the best match position is identified. The video encoder processes the MV along with encoding parameters for achieving video compression.

However, the block based motion estimation is computationally intensive and may consume considerable computational power of the video encoder. Many existing methods use full search (FS) that evaluates all the search points in a search window.

Some existing methods reduce the number of search points in the search range or leverage decimated reference frames. However, in these approaches, all the pixels in the target macroblock and the macroblock of the reference frame currently being compared are used to calculate the cost metric. Thus, the existing method consumes a considerable amount of computational power of a video encoder.

Moreover, usage of techniques involving higher computations reduces time efficiency during motion estimation implemented in software. In cases of motion estimation implemented in hardware, the existing computationally intensive cost metric computation methods increase the hardware required, which effectively increases the cost of the video encoder.

Thus, a method that effectively reduces computational intensity of the cost metric computation would further improve encoding efficiency.

### SUMMARY

According to aspects of exemplary embodiments, there are provided a method and a video encoder for block matching based motion estimation by computing a first cost metric based on partial pixels including border pixels of a target macroblock in a candidate frame and a macroblock in a reference frame. The first cost metric is a measure of comparison between the target macroblock and the macroblock of the reference frame currently being compared with the target macroblock.

According to aspects of exemplary embodiments, there are provided a method and a video encoder for block matching based motion estimation by computing the first cost metric based on the border pixels and center pixels of the target macroblock in the candidate frame and the macroblock in the reference frame.

According to an aspect of an exemplary embodiment, there is provided a method of enhancing accuracy of motion estimation by computing a second cost metric based on entire pixels of the target macroblock and the macroblock of the reference frame when the first cost metric satisfies a specified condition.

According to an aspect of an exemplary embodiment, there is provided a method of enhancing accuracy of motion estimation by computing the second cost metric based on the border pixels and center pixels by selecting thickness of the border pixels greater than the thickness of the border pixels used for first cost metric computation.

According to an aspect of an exemplary embodiment, there is provide a method for block matching based motion estimation including computing, by a video encoder, a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame, determining, by the video encoder, whether the first cost metric is less than a first minimum value, updating, by the video encoder, the first minimum value to the first cost metric, and updating a matching position to the search point, in response to determining that the first cost metric is less than the first minimum value, and identifying, by the video encoder, a search point corresponding to the matching position as a best matching position for the motion estimation.

According to an aspect of an exemplary embodiment, there is provided a video encoder including a motion estimation unit configured to compute a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame, determine whether the first cost metric is less than a first minimum value, update the first minimum value to the first cost metric, and update a matching position to the search point in response to determining that the first cost metric is less than the first minimum value, and identify a search point corresponding to the matching position as a best matching position for motion estimation.

According to an aspect of an exemplary embodiment, there is provided a computer program product including a non-transitory computer-readable storage medium having embodied thereon computer-readable code which, when executed, causes a video encoder to execute a block matching based motion estimation method including computing a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame, determining whether the first cost metric is less than a first minimum value, updating the first minimum value to the first cost metric, and updating a matching position to the search point in response to determining that the first cost metric is less than the first minimum value, and identifying a search point corresponding to the matching position as a best matching position for motion estimation.

The above and other aspects will be better appreciated and understood when considered in conjunction with the following description and the accompanying drawings. It should be understood, however, that the following descriptions, while indicating exemplary embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

Exemplary embodiments are illustrated with respect to the accompanying drawings, throughout which like reference letters indicate corresponding parts in the various figures. The exemplary embodiments herein will be better understood from the following description with reference to the drawings, in which:

FIG. 1 illustrates a block diagram of an electronic device for block matching based motion estimation, according to an exemplary embodiment;

FIG. 2 illustrates a diagram explaining the target macroblock indicating the pixels that are used for computation of a first cost metric for a candidate frame and a reference frame, according to an exemplary embodiment;

FIG. 3 illustrates a flowchart of a method for block matching based motion estimation by computing the first cost metric, according to an exemplary embodiment;

FIG. 4 illustrates a flowchart of a method for block matching based motion estimation by computing the first cost metric and a second cost metric, according to an exemplary embodiment;

FIGS. 5A and 5B illustrate diagrams explaining sub-macroblocks used for block matching based motion estimation, according to exemplary embodiments; and

FIG. 6 illustrates a block diagram of a computing environment implementing block matching based motion estimation, according to an exemplary embodiment.

### DETAILED DESCRIPTION OF EXEMPLARY EMBODIMENTS

Exemplary embodiments and the various features and advantageous details thereof are explained more fully with reference to the accompanying drawings and detailed in the following description. Descriptions of well-known components and processing techniques are omitted to avoid unnecessarily obscuring the exemplary embodiments. The examples used herein are intended merely to facilitate an understanding of ways in which the exemplary embodiments can be practiced and to further enable those of skill in the art to practice the exemplary embodiments. Accordingly, the examples should not be construed as limiting the scope of the exemplary embodiments.

As used herein, the term “and/or” includes any and all combinations of one or more of the associated listed items.

Expressions such as “at least one of,” when preceding a list of elements, modify the entire list of elements and do not modify the individual elements of the list.

It will be understood that the terms “comprise” and/or “comprising” when used in this specification, specify the presence of stated features, integers, steps, operations, elements, and/or components, but do not preclude the presence or addition of one or more other features, integers, steps, operations, elements, components, and/or groups thereof.

Also, the terms “unit,” “module,” etc. mean units for processing at least one function or operation and may be embodied as hardware, software, or a combination thereof.

The exemplary embodiments achieve a method and a video encoder for block matching based motion estimation. The motion estimation is performed to locate a motion vector (MV) between a reference frame and a candidate frame. The MV identifies motion of the objects in frames of the video being compressed. The method includes performing motion estimation by computing a first cost metric based on partial pixels that include border pixels of a target macroblock of the candidate frame and a macroblock of the reference frame.

The partial pixels may include the border pixels and the center pixels.

The first cost metric may be a measure of comparison between the candidate frame and a reference frame, in which the computation involves partial pixels of the candidate frame and corresponding pixels of the macroblock in the reference frame associated with a current search point in the reference frame.

The number of search points in a search window may be defined by a search point algorithm.

The proposed motion estimation method may be applied for any search point algorithm, such as full search, diamond search and the like. The proposed motion estimation method may be adapted to any motion estimation method by using the cost metric function as defined by the particular motion estimation method. The motion estimation method used includes using a Sum of Absolute Difference (SAD) or Mean of Absolute Difference (MAD) or the like. Further, the method includes enhancing the accuracy of the block based motion estimation by computing a second cost metric of the target macroblock and the current macroblock of the reference frame.

The second cost metric may be computed using entire pixels of the target macroblock.

The second cost metric may be computed using the border pixels and center pixels by selecting thickness of the border pixels greater than the thickness of the border pixels used during first cost metric computation.

Unlike conventional methods that compute a cost metric based on entire pixels of the macroblocks of the candidate and the reference frame, the proposed motion estimation method reduces mathematical operations involved in cost metric computation by reducing the number of pixels involved in the first cost metric computation, thereby providing good accuracy in motion estimation with computation of the first cost metric.

In cases that higher motion estimation accuracy is required, additional computation of the second cost metric may be provided, for example during compression of a video having heavy motion.

The second cost metric computation may be based on entire pixels of the target macroblock.

The proposed motion estimation method may further reduce computation of the second cost metric by computing the second cost metric based on only border pixels with variable thickness, with or without center pixels. The increased border thickness improves accuracy of motion estimation while providing reduced computation as compared to usage of entire pixels of the target macroblock.

Thus, time efficient motion estimation and time efficient compression of the video encoder may be attained. The time, in CPU cycles, saved may be used to increase the number of search points in a given motion estimation method. The increase in number of search points provides improved accuracy of the motion estimation and thereby improves quality of video encoding of the video encoder. In case of hardware implementation, reduced the hardware cost of a motion estimation unit may be attained.

Referring now to the drawings, in which similar reference characters denote corresponding features consistently throughout the figures, there are shown exemplary embodiments.

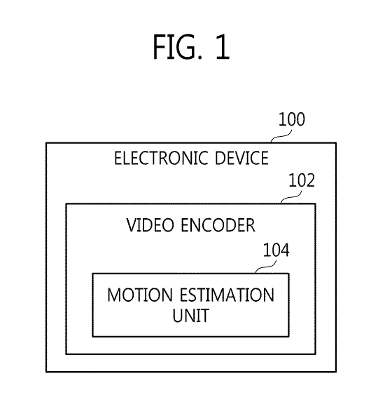

FIG. 1 illustrates a block diagram of an electronic device 100 block matching based motion estimation, according to an exemplary embodiment.

The electronic device 100 includes a video encoder 102. The video encoder includes a motion estimation unit 104. The motion estimation unit 104 is configured to perform motion estimation and identify a motion vector (MV) for the target macroblock of the candidate frame by comparing the target macroblock of the candidate frame with each macroblocks of the reference frame identified by the search point. The search for a best matching block, of the reference frame, with the target macroblock is performed within a search window in the reference frame. The first cost metric is computed using only the partial pixels of the target macroblock and the current macroblock (of the reference frame).

Each macroblock within the search window is identified by the search point in the reference frame.

The partial pixels may include only the border pixels, but the partial pixels may include the border pixels and one or more center pixels.

The partial pixels may include a pre-defined pattern of pixels that includes the border pixels, the center pixels, and one or more pixels from the remaining region of the target macroblock.

The border thickness of the border pixels may be one pixel thick or multiple pixels thick. The thickness of the border pixels may vary along each border. The motion estimation unit 104 is configured to select the thickness of the border pixels used for the first cost metric computation based on the accuracy required for the motion estimation.

The motion estimation unit 104 is configured to locate a best matching position in the reference frame, corresponding to the target block, by identifying the search point (that identifies the macroblock of reference frame) at which the first cost metric provides a minimum value.

The motion estimation unit 104 is configured to divide a candidate frame into multiple macroblocks, and select each macroblock as the target macroblock to compute the first cost metric for motion estimation of the corresponding macroblock.

The motion estimation unit 104 is configured to select the size of the macroblock based on whether motion in a video being compressed is heavy or light. The size of the macroblock reduces as the motion in the video increases.

Whenever higher accuracy is required for motion estimation, the motion estimation unit 104 is configured to compute the second cost metric for the search point for which the computed first cost metric is below a first minimum value.

The second cost metric may be computed using entire pixels of the target macroblock and the current macroblock (of the reference frame) being compared. Alternatively, the second cost metric may be computed using the border pixels with or without the center pixels, with thickness of the border pixels greater than that used for the first cost metric computation. The motion estimation unit 104 is configured to preset the first minimum value to an initial value and update the first minimum value during the motion estimation process for each search point. Thus, when both the first cost metric and second cost metric are used for motion estimation by the motion estimation unit 104, the motion estimation unit 104 is configured to locate the best matching position in the reference frame, for the target block, by identifying the search point at which the second cost metric has a minimum value.

Throughout the description the proposed method is explained for a single target macroblock, however all macroblocks of the candidate frame are processed in similar manner as described by the proposed method for motion estimation of these macroblocks.

FIG. 1 illustrates a limited overview of the electronic device 100, but other embodiments are not limited thereto. The labels provided to each module or component are only for illustrative purpose and do not limit the scope of the exemplary embodiments. Further, the one or more modules may be combined or separated to perform the similar or substantially similar functionalities without departing from the scope of the exemplary embodiment. Furthermore, the electronic device 102 may include various other modules or components interacting locally or remotely along with other hardware or software components to communicate with each other. For example, the component may be, but is not limited to, a process running in the controller or processor, an object, an executable process, a thread of execution, a program, or a computer.

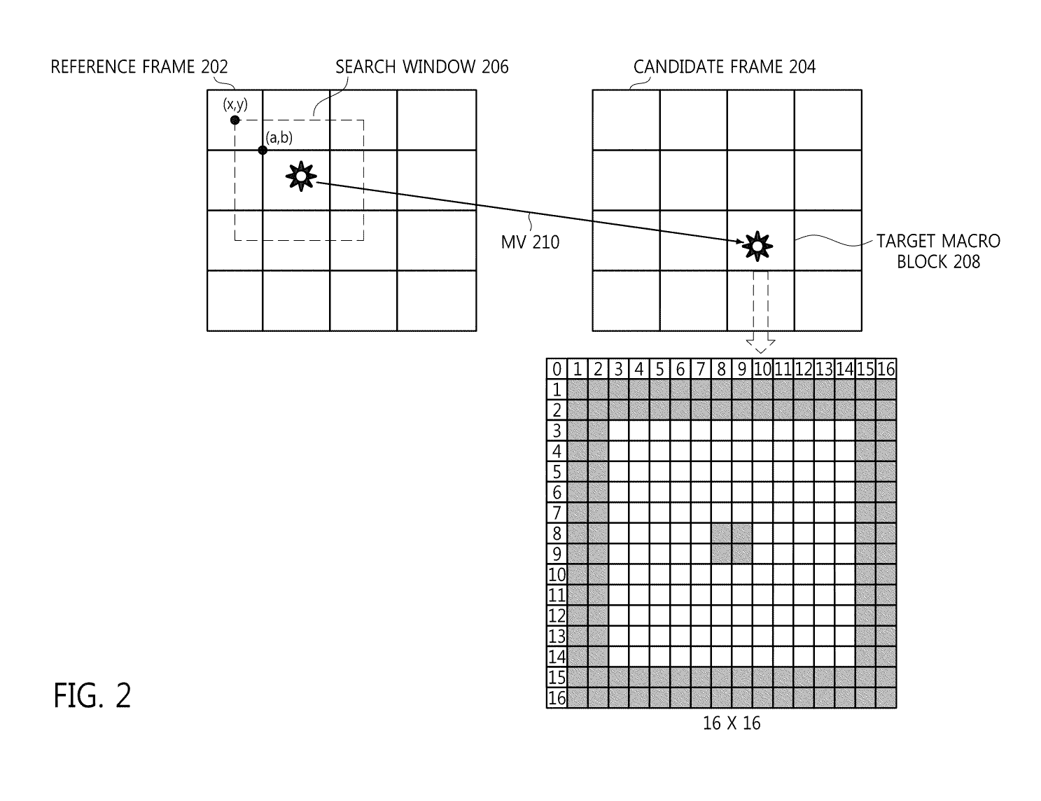

FIG. 2 illustrates a diagram explaining a target macroblock indicating the pixels that are used for computation of the first cost metric for a candidate frame and the reference frame, according to an exemplary embodiment.

FIG. 2 illustrates the reference frame 202, the candidate frame 204, the search window 206, the target macroblock 208, and the motion vector (MV) 210. The reference frame 202 and the candidate frame 204 are compared using the first cost metric measure to estimate motion in the candidate frame 204. The motion estimation is performed for every macroblock of the candidate frame 204 by comparing each macroblock referred as the target macroblock 208 with the reference frame 202 by computing the first cost metric. The search for the target macroblock 208 is performed over a search window 206 by computing the first cost metric at every search point of the reference frame. For example, pixel position (x,y) identifies a macroblock in the search window 206 of the reference frame 202. The search points within the search window 206 are identified by the search algorithm used by the motion estimation unit 104. For example, the search points may correspond to consecutive pixels in the search window 206 of the reference frame 202. For example, the search points may be identified based on diamond search pattern and the like.

In FIG. 2, the first cost metric for every search point is computed using the border pixels and the center pixels. The enlarged view of the target macroblock 208 indicates the macroblock of size 16×16 pixels. The partial pixels of the target macroblock 208 that are used for computation of the first cost metric include border pixels having border thickness of two pixels and center pixels of size 2×2.

For example, computing of the first cost metric using the Sum of Absolute Difference (SAD) cost metric, the Mean of Absolute Difference (MAD) cost metric and a Mean Squared Error (MSE) cost metric function is based on the equations 1, 2 and 3 respectively that are provided below:

SAD=Σ|C(i,j)−R(i,j)| Equation (1)

MAD=(1/N²)×Σ|C(i,j)−R(i,j)| Equation (2)

MSE=(1/N²)×Σ(C(i,j)−R(i,j))² Equation (3)

In Equations 1 to 3, i,jεW and W is the set of pixels corresponding to partial pixels used for first metric computation that include border pixels with or without center pixels in which, N (here 16) is side of the macroblocks of N×N (16×16) size in the candidate frame at Cᵢⱼ and Rij are pixels being compared in candidate frame and the reference frame respectively. Thus, for computation of the first cost metric border pixels and center pixels of the target macroblock 208 are compared with border pixels and center pixels of the current macroblock in the reference frame 202 associated with the current search point.

However, based on the accuracy required for motion estimation, the border thickness may vary from one pixel to multiple pixels and the center pixels may or may not be used for computation of the first cost metric.

Further, once the first cost metric is computed for all search points, the search point providing minimum value of the first cost metric is identified as the best matching position of the reference frame 202 with the target block 204. As shown in the FIG. 2, the best matching macroblock is the macroblock identified by the search point (a, b) as the first cost metric computation for the search point (a,b) is minimum.

The motion estimation unit 104 may be configured to compute the second cost metric using entire or partial pixels of the target macroblock 208 to improve the accuracy of motion estimation.

The second cost metric computation may employ entire pixels of the target macroblock and entire pixels of the macroblock of the reference frame identified by the search point. Thus, computation of second cost metric uses Equation 1, 2 or 3 described above, however i,j belong to the set of pixels ‘W’ that includes entire pixels of the target macroblock and the reference macroblock.

The proposed motion estimation method may further reduce computation of the second cost metric by computing the second cost metric using only border pixels with variable thickness with or without center pixels. The variable thickness used for the second cost metric computation is greater than thickness of the border pixels used for the first cost metric computation to provide higher accuracy for motion estimation. Thus, computation of second cost metric may use the Equation 1, 2 or 3 described above, however i,j belong to the set of pixels ‘W’ that includes only border pixels of the target macroblock 208 and the reference macroblock of the reference frame 202.

The proposed method can be applied for any macroblock size, such as 8×16, 16×8, 16×16, and is not limited to only border pixels and center pixels. Further, usage of any pattern of pixels that include the border pixels with or without the center pixel and any intermediate pixels of the macroblocks for computation of the first metric is within the scope of the exemplary embodiment.

An example of calculation of the Sum of Absolute Difference (SAD) as the cost metric used for motion estimation to drive the motion vector for the 16×16 macroblock indicates the proposed method reduces computational power as compared to conventional methods. For the macroblock in FIG. 2 with size 16×16 pixels, the border pixels have the border thickness of 2 pixels and center pixel block is 2×2 pixels.

The quantity of operations required to calculate the SAD for a given search point using all the pixels by existing methods in a 16×16 macroblock is: 2×(16×16)−1=511.

The quantity of operations required to calculate the SAD for a given search point using border pixel thickness=2 pixels and center pixels=2×2 is: 2×{(4×16)+(4×12)}+{2×(2×2)}−1=231.

Thus, the above calculations show that using the proposed method reduces the number of operations (mathematical computations) by a factor of 2.2.

For a macroblock of size is larger than 16×16, the proposed method provides higher reduction in required computations. In High Efficiency Video Coding (HEVC), the maximum macroblock size can be 64×64. For a bigger macroblock size, the border thickness may be increased to improve the accuracy of the proposed method. For example using border thickness of 4 pixels and center pixels of size 16×16, the number of mathematical computations is reduced by a factor of 4, as shown below:

The quantity of operations required to calculate SAD using all the pixels as performed by existing methods in a 64×64 macroblock is as follows:

2×(64×64)−1=8191

The quantity of operations required to calculate SAD using the proposed method with border pixel thickness=4 pixels and center pixels=16×16 is as follows:

2{(8×64)+(8×56)}+{2×(8×8)}−1=2047

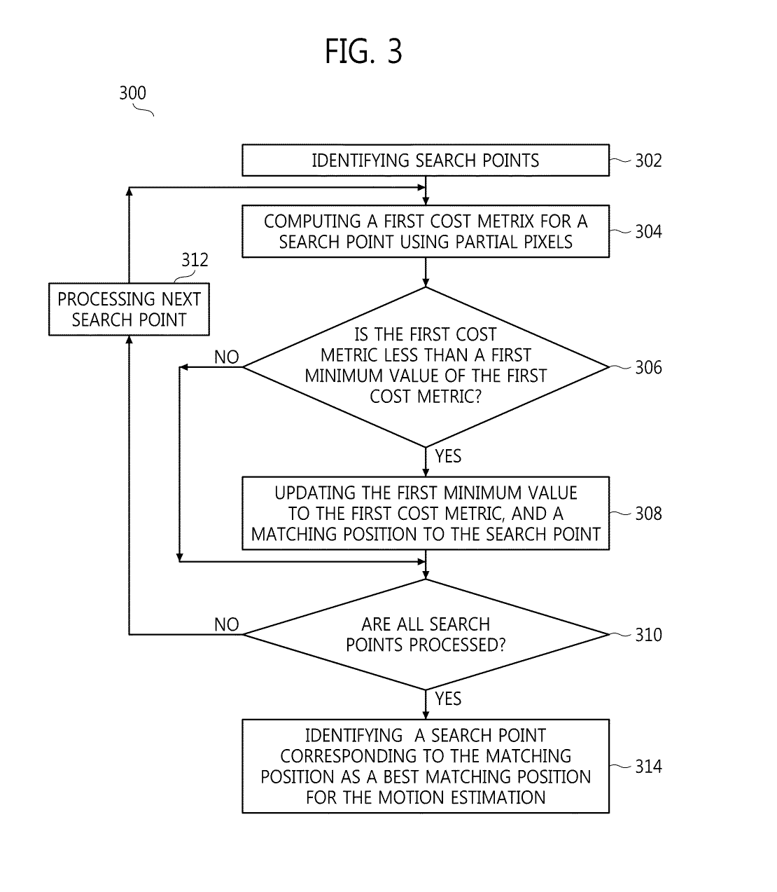

FIG. 3 illustrates a flowchart of a method for block matching based motion estimation based on computation of the first cost metric, according to an exemplary embodiment.

In FIG. 3, at step 302, search points are identified based on the search algorithm used by the method 300. The motion estimation unit 104 may identify search points based on the search algorithm used.

At step 304, the first cost metric for the search point in the reference frame is computed using partial pixels of the target macroblock and partial pixels of the macroblock of the reference frame identified by the search point. The motion estimation unit 104 may compute the first cost metric for the search point using partial pixels of the target macroblock and partial pixels of the macroblock of the reference frame identified by the search point. Computation of the first cost metric is computed as described in FIG. 2, with Cᵢⱼ pixels of the candidate frame (corresponding to the target block) being compared with the Rᵢⱼ pixels (corresponding to the macroblock identified by the search point) of the reference frame respectively.

The border pixels may be used for computation of the first cost metric. The border pixels may be one pixel thick or multiple pixels thick based on the accuracy required for motion estimation by the video encoder 102.

The partial pixels may include one or more center pixels and the border pixels.

At step 306, it is determined whether the first cost metric is less than the first minimum value of the first cost metric. The motion estimation unit 104 may determine whether the first cost metric is less than a first minimum value of the first cost metric, in which the first minimum value is preset to a very high value and is dynamically updated when each search point in the reference frame is processed for motion estimation.

At step 308, the first minimum value is updated to the first cost metric, and update a matching position to the search point in response to determining that the first cost metric computed at step 304 is less than the first minimum value. The motion estimation unit 104 may update the first minimum value to the first cost metric, and update the matching position to the search point. If at step 306, it is determined than the computed first cost metric for the search point is greater than the first minimum value, then at step 312, the next successive search point is processed. If at 306, it is determined that the first cost metric is less than the first minimum value, it may be determined whether all search points in the reference frame are processed, in step 310.

At step 310, it is determined whether all search points in the reference frame are processed. The motion estimation unit 104 may determine whether all search points are processed. If at step 310, it is determined that all search points are not processed, then at step 312, the method 300 includes processing a next search point. The motion estimation unit 104 may process next search point. Thus, with every search point processing, the steps of method 300 are repeated, and for each iteration, the first minimum value and the matching position may be updated when the computed first cost metric is greater than the current first minimum value.

Upon processing all the search points, at step 314, a search point corresponding to the matching position may be identified as a best matching position for the motion estimation as that search point provides minimum value of the first cost metric value. the motion estimation unit 104 may identify the search point corresponding to the matching position as the best matching position for the motion estimation. Thus, the macroblock of the reference frame identified by the search point associated with the best matching position is the best matching block with the target block.

The method of FIG. 3 is described for one target block, however as understood by a person skilled in the art, the method is repeated for all the macroblocks of the candidate frame for motion estimation and motion vector generation corresponding to each macroblock of the candidate frame. Further, the motion vectors, generated using method, may be used by the video encoder 102 for further processing along with various other parameters to compress the video.

The various actions, acts, blocks, steps, and the like in the method of FIG. 3 may be performed in the order presented, in a different order, or simultaneously. Further, some actions, acts, blocks, steps, and the like may be omitted, added, modified, skipped, and the like without departing from the scope of the exemplary embodiment.

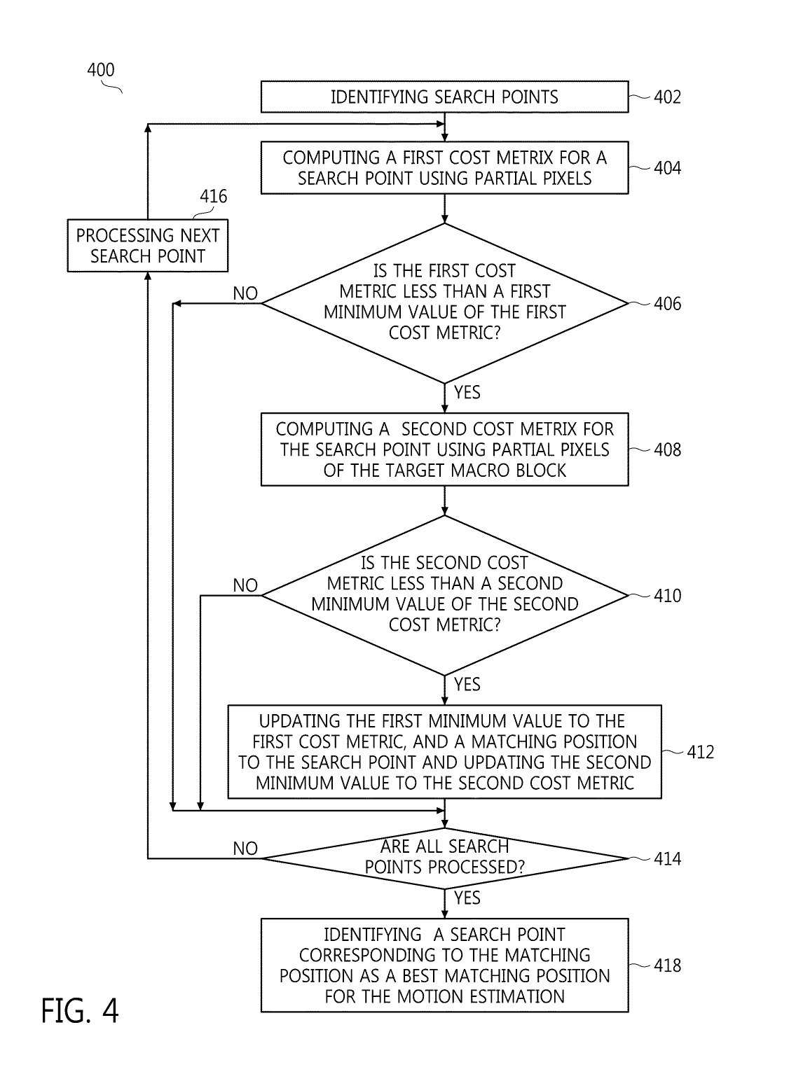

FIG. 4 illustrates a flowchart of a method for block matching based motion estimation based on the computation of the first cost metric and the second cost metric, according to an exemplary embodiment.

In FIG. 4, the steps 402, 404 and 406 of the method 400 are similar to the steps 302, 304 and 306 of method 300, respectively, and therefore a redundant description thereof if omitted for brevity.

If at step 406, it is determined than the computed first cost metric for the search point is greater than the first minimum value, then at step 416, the next successive search point is processed.

Upon determining, at step 406, that the first cost metric is less than the first minimum value, then at step 408, the second cost metric for the search point (same search point for which the first cost metric is computed) is computed. If at 406, it is determined that the first cost metric is less than the first minimum value, it is determined whether all search points are processed at step 414, and the process may be iterated as necessary.

The second cost metric computation may use entire pixels of the target macroblock and entire pixels of the macroblock of the reference frame identified by the search point.

The proposed motion estimation method may further reduce computation of the second cost metric by computing the second cost metric using partial pixels that include only border pixels with variable thickness with or without center pixels.

The motion estimation unit 104 may compute the second cost metric for the search point using all pixels of using all (entire) pixels of the target macroblock and all pixels of the macroblock of the reference frame identified by the search point. The second cost metric is computed as described in FIG. 2, with Cᵢⱼ pixels of the candidate frame (corresponding to the target block) being compared with the Rᵢⱼ pixels of the reference frame respectively, where the entire pixels of the target block are used.

At step 410, it is determined whether the second cost metric is less than the second minimum value. The motion estimation unit 104 may determine whether the second cost metric is less than the second minimum value. If at 410, it is determined that the second cost metric is less than the second minimum value, then it is determined whether all search points are processed at step 414.

At step 412, the first minimum value may be updated to the first cost metric, the matching position may be updated to the search point (currently being processed), and the second minimum value may be updated to the second cost metric. The motion estimation unit 104 may update the first minimum value to the first cost metric, update the matching position to the search point, and update the second minimum value to the second cost metric.

At step 414, it is determined whether all search points in the reference frame are processed.

The motion estimation unit 104 may determine whether all search points in the reference frame are processed.

If at step 414, it is determined that all search points are not processed, then at step 416, the next search point is processed.

The motion estimation unit 104 may process the next search point.

Thus, with every search point processing, the steps of method 400 are repeated, and with each iteration the first minimum value and the matching position may be updated when the computed first cost metric and the second cost metric are less than the current first minimum value and the current second minimum value respectively.

Upon processing all the search points, at step 418, the search point corresponding to the matching position is identified as the best matching position for the motion estimation.

The various actions, acts, blocks, steps, and the like in FIG. 4 may be performed in the order presented, in a different order, or simultaneously. Further, some actions, acts, blocks, steps, and the like may be omitted, added, modified, skipped, and the like without departing from the scope of the invention.

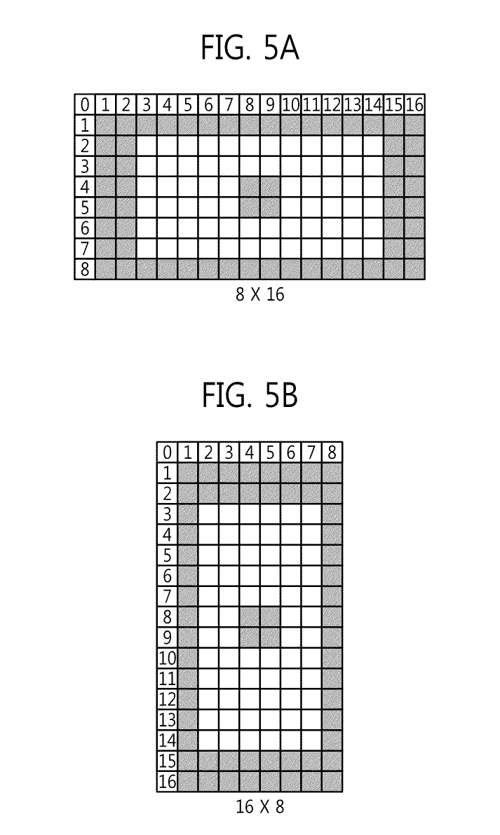

FIGS. 5A and 5B illustrate diagrams explaining sub-macroblocks used for block matching based motion estimation, according to exemplary embodiments.

FIG. 5A shows 8×16 sub-macroblock with the border pixels having vertical border pixels that are two pixel thick, horizontal border pixels that are one pixel thick and a center pixel block of size 2×2 that is used according to FIG. 3 and according to FIG. 4 for computation of the cost metric during motion estimation of a 8×16 sub-m macroblock.

FIG. 5B shows 16×8 sub-macroblock with the vertical border pixels that are one pixel thick, horizontal border pixels that are two pixel and the center pixel block of size 2×2 that is used according to FIG. 3 and according to FIG. 4 for computation of the cost metric during motion estimation of a 8×16 sub-macroblock.

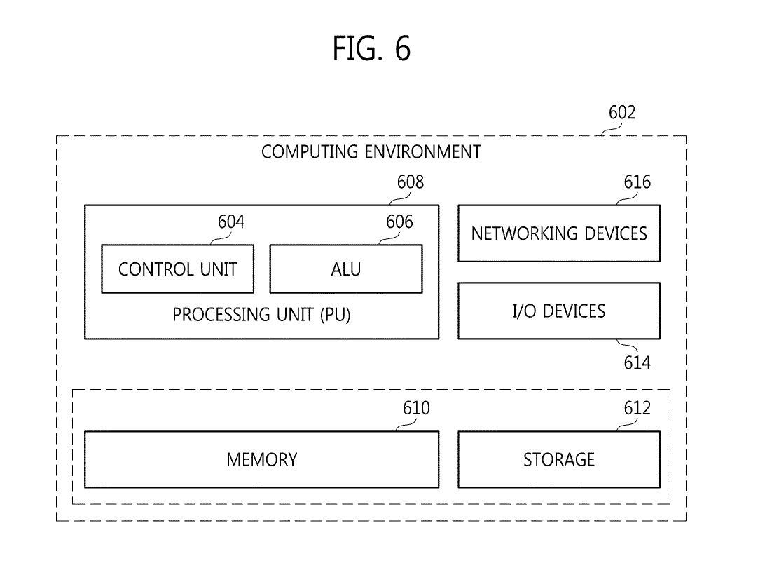

FIG. 6 illustrates a block diagram of a computing environment implementing block matching based motion estimation, according to an exemplary embodiment.

As shown in the FIG. 6, the computing environment 602 includes at least one processing unit 608 that is equipped with a control unit 604 and an Arithmetic Logic Unit (ALU) 606, a memory 610, a storage unit 612, networking devices 616, and input/output (I/O) devices 614.

The processing unit 608 is responsible for processing computer-readable instructions. For example, the processing unit 608 may execute computer-readable instructions for performing the methods of FIG. 3 and FIG. 4. The processing unit 608 receives commands from the control unit to perform processing. Further, any logical and arithmetic operations involved in the execution of the instructions are computed with the help of the ALU 606.

The overall computing environment 602 can be composed of multiple homogeneous and/or heterogeneous cores, multiple CPUs of different kinds, special media and other accelerators. The processing unit 608 is responsible for processing the instructions of an algorithm, such as for example the methods of FIG. 3 and FIG. 4. Further, the plurality of processing units 608 may be located on a single chip or over multiple chips.

The algorithm of computer-readable instructions and codes required may be stored in either the memory unit 610 or the storage 612 or both. During execution, the instructions may be fetched from the corresponding memory 610 and/or storage 612, loaded into memory 610, and executed by the processing unit 608.

In case of any hardware implementations, various networking devices 616 or external I/O devices 614 may be connected to the computing environment to support the implementation through the networking unit and the I/O device unit.

The exemplary embodiments disclosed herein can be implemented through at least one software program running on at least one hardware device and performing network management functions to control the elements. The elements shown in FIGS. 1 and 6 include blocks that may be at least one of a hardware device, or a combination of hardware device and software.

The foregoing description will so fully reveal the nature of the exemplary embodiments herein that artisans of ordinary skill may, by applying current knowledge, readily modify and/or adapt for various applications such specific exemplary embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the exemplary embodiments herein have been described in terms of preferred embodiments, those skilled in the art will recognize that the exemplary embodiments herein may be practiced with modification within the spirit and scope of the embodiments as described herein.

1. A block matching based motion estimation method, the method comprising:
computing, by a video encoder, a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame;
determining, by the video encoder, whether the first cost metric is less than a first minimum value;
updating, by the video encoder, the first minimum value to the first cost metric, and updating a matching position to the search point, in response to determining that the first cost metric is less than the first minimum value; and
identifying, by the video encoder, a search point corresponding to the matching position as a best matching position for the motion estimation.

2. The method as in claim 1, wherein the updating and matching comprises:
computing a second cost metric, for the search point, using one of entire pixels, and the subset of pixels of the target macroblock and the macroblock of the reference frame;
determining whether the second cost metric is less than a second minimum value;
updating the second minimum value to the second cost metric in response to determining that the second cost metric is less than the second minimum value; and
updating the first minimum value to the first cost metric, and updating the matching position to the search point.

3. The method of claim 1, wherein the subset of pixels comprises border pixels, and wherein the border pixels are at least one pixel thick.

4. The method of claim 1, wherein the subset of pixels comprises at least one center pixel and the border pixels.

5. A video encoder comprising:
a motion estimation unit configured to:
compute a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame;
determine whether the first cost metric is less than a first minimum value;
update the first minimum value to the first cost metric, and update a matching position to the search point in response to determining that the first cost metric is less than the first minimum value; and
identify a search point corresponding to the matching position as a best matching position for motion estimation.

6. The video encoder of claim 5, wherein the motion estimation unit is further configured to update the first minimum value to the first cost metric, and update the matching position to the search point by:
computing a second cost metric, for the search point, using entire pixels of the target macroblock and entire pixels of the macroblock of the reference frame identified by the search point;
determining whether the second cost metric is less than a second minimum value;
updating the second minimum value to the second cost metric in response to determining that the second cost metric is less than the second minimum value; and
updating the first minimum value to the first cost metric, and updating the matching position to the search point.

7. The video encoder of claim 5, wherein the subset of pixels comprises border pixels, and
wherein the border pixels are at least one pixel thick.

8. The video encoder of claim 5, wherein the subset of pixels comprises at least one center pixel and the border pixels.

9. A computer program product comprising a non-transitory computer-readable storage medium having embodied thereon computer-readable code which, when executed, causes a video encoder to execute a block matching based motion estimation method, the method comprising:
computing a first cost metric for a search point among plurality of search points in a reference frame with reference to a target macroblock of a candidate frame based on a subset of pixels of the target macroblock and a subset of pixels of a macroblock of the reference frame identified by the search point, wherein the subset of pixels of the macroblock of the reference frame includes at least one of border pixels and center pixels of the reference frame;
determining whether the first cost metric is less than a first minimum value;
updating the first minimum value to the first cost metric, and updating a matching position to the search point in response to determining that the first cost metric is less than the first minimum value; and
identifying a search point corresponding to the matching position as a best matching position for motion estimation.
